(19) United States
(12) Patent Application Publication
(10) Pub. No.: US 2025/0253897 A1
(43) Pub. Date: Aug. 7, 2025

(54) DIGITAL CONTROLLABLE SCATTERER CONTROLLER AND METHOD FOR USE IN THE SAME

(71) Applicant: HUAWEI TECHNOLOGIES CO., LTD., Shenzhen (CN)

(72) Inventors: Mustapha Amara, Boulogne Billancourt (FR); Sami Mekki, Boulogne Billancourt (FR); Mohamed Kamoun, Boulogne Billancourt (FR); Melissa Duarte Gelvez, Boulogne Billancourt (FR)

(73) Assignee: HUAWEI TECHNOLOGIES CO., LTD., Shenzhen (CN)

(21) Appl. No.: 19/189,065

(22) Filed: Apr. 24, 2025

Related U.S. Application Data
(63) Continuation of application No. PCT/EP2022/079564, filed on Oct. 24, 2022.

(51) Int. Cl. H04B 7/04

(52) U.S. Cl. CPC H04B 7/04013

(57) ABSTRACT

A DCS controller configured to control a digitally controllable scatterer, DCS, to simultaneously serve a subset of multiple receivers, where the DCS includes a plurality of scattering elements arranged on a scattering surface. The DCS controller is configured to determine a single-user codeword for each of the multiple receivers, where the single-user codeword defines a set of scattering elements of the scattering surface of the DCS for the respective receiver and a respective phase shift configuration for each scattering element in the set of scattering elements. The DCS controller is configured to determine a required signal gain for each of the multiple receivers and determine a subset of receivers based on the required signal gains. The DCS controller is configured to determine a subset of scattering elements of the scattering surface for each receiver in the subset of receivers and determine a multiple-user codeword based on the subsets.

### CROSS-REFERENCE TO RELATED APPLICATIONS

This application is a continuation of International Application No. PCT/E P2022/079564, filed on Oct. 24, 2022, the disclosure of which is hereby incorporated by reference in its entirety.

### TECHNICAL FIELD

The present disclosure relates generally to the field of wireless communication and more specifically, to a digital controllable scatterer (DCS) controller and a method for use in the DCS controller.

### BACKGROUND

Generally, a digital controllable scatterer (DCS) is defined as a large surface with a huge number of scattering elements that can be configured independently. The DCS has channel programming capabilities as well as focusing capabilities that can be used in order to focus the energy towards a given user equipment (UE). The focusing capabilities enables the DCS to serve a UE that cannot be served directly while controlling the achieved signal-to-noise ratio (SNR). However, it becomes technically challenging to serve multiple UEs at the same time through the same DCS. Typically, a codeword, i.e., a phase configuration for the DCS is designed to focus on a given position in space. This implies that when two users (or UEs) are separated in space then focusing simultaneously while keeping a required link budget becomes unfeasible as the two respective codewords are significantly different and do not provide the required SNR levels to each of the UEs to ensure a proper communication. Moreover, the DCS being the large surface can be split into sub regions and each sub region can be dedicated to serving a given UE. The problem becomes then the following: what region or what elements of the DCS should be associated with each of the UEs in a given set of UEs in order to ensure properly serving each of the UEs with the required SNR. The problem is solved by splitting the DCS into vertical and/or horizontal sub regions where each sub region is allocated to a specific user. Although the proposed solution is easy to implement however, not preferred because of not considering various parameters, such as structure and orientation of an optimal serving plane, orientation of an optimal beamformer to focus the energy towards intended users, achieved SNR levels for each of the targeted UEs and the like.

Currently, different ways have been developed to configure the DCS (or DCSs) phases in multi-user (MU) scenarios where the phases are optimized based on a target objective function. Examples of the target objective function include sum rate, minimum mean square error (MMSE), outage, minimize interference, maximize effective rank, maximize minimum singular value, geometric mean of SINR, worst case sum rate, etc. The different works consider various assumptions on channel state information (CSI), like full perfect CSI, full noisy CSI or statistical CSI. In order to simplify the CSI requirements and/or the algorithms to solve the optimization problems, many alternative options are considered, for example, associating only one user per DCS, beam training, Bayesian optimization, random beamforming, DCS partitioning, radio environment maps, etc. In spite of aforementioned solutions, there exists a technical problem of configuring the DCS in order to serve the multiple users simultaneously while maintaining the required SNR levels for each user.

Therefore, in light of the foregoing discussion, there exists a need to overcome the aforementioned drawbacks associated with the conventional ways of configuring the DCS phases in MU scenarios.

### SUMMARY

The present disclosure provides a digital controllable scatterer (DCS) controller and a method for use in the DCS controller. The present disclosure provides a solution to the existing problem of configuring the DCS in order to serve the multiple users simultaneously while maintaining the required SNR levels for each user. An objective of the present disclosure is to provide a solution that overcomes at least partially the problems encountered in the prior art and provides an improved DCS controller and a method for use in the DCS controller.

One or more objectives of the present disclosure is achieved by the solutions provided in the enclosed independent claims. Advantageous implementations of the present disclosure are further defined in the dependent claims.

In one aspect, the present disclosure provides a DCS controller configured to control a digitally controllable scatterer, DCS, to simultaneously serve a subset of the multiple receivers (Rx), the multiple receivers (Rx) comprising at least a first receiver (Rx₁) and a second receiver (Rx₂) being located in different locations, wherein the DCS comprises a plurality of scattering elements arranged on a scattering surface, and wherein the DCS controller is configured to determine a single-user codeword (Cᵢ) for each of the multiple receivers (Rxᵢ), wherein a single-user codeword defines a set of scattering elements of the scattering surface of the DCS for the respective receiver (Rxᵢ) and a respective phase shift configuration for each scattering element in the set of scattering elements. The DCS controller is further configured to determine a required signal gain (Gᵢ) for each of the multiple receivers (Rxᵢ) and determine a subset of receivers (Rx₁, Rx₂) based on the required signal gains (G₁, G₂). The DCS controller is further configured to determine a subset (Sᵢ) of scattering elements of the scattering surface for each receiver (Rxᵢ) in the subset of receivers (Rx₁, Rx₂), wherein the subset (Sᵢ) of scattering elements of the scattering surface for a receiver (Rxᵢ) is determined to satisfy the required signal gain (Gᵢ) for that receiver (Rxᵢ) and subsets (Sᵢ) are disjoint. The DCS controller is further configured to determine a multiple-user codeword (Cₘ) based on the subsets, wherein the multiple-user codeword (Cₘ) defines the phase configuration for all subsets of scattering elements of the (scattering) surface of the DCS and control the DCS based on the multiple-user codeword (Cₘ) for data transmission.

The disclosed DCS controller is configured to control the DCS in such a way that the DCS serves simultaneously a subset of the multiple receivers while maintaining the required SNR levels for each receiver. Alternatively stated, the DCS controller is configured to control the DCS based on the multiple-user codeword (Cₘ) which enables the DCS to simultaneously serve the subset of the multiple receivers with the single multi user codeword which can be constructed as a function of the multiple single-user codewords. The DCS controller is configured to generate the single-user codeword using a virtual ellipsoid technique. The single-user codeword defines the set of scattering elements of the DCS for each receiver. Thereafter, the DCS controller is configured to determine the required signal gain for each of the multiple receivers and determine the subset of receivers based on the required signal gains. Thereafter, the beam construction is used at the transmitter and used to focus the energy on the allocated DCS elements which further scatters the focused energy towards each of the multiple receivers.

In an implementation form, the DCS controller is further configured to determine the subset of receivers (Rx₁, Rx₂) based on the single-user codewords (C₁, C₂).

In a further implementation form, the DCS controller is further configured to determine the subset of receivers (Rx₁, Rx₂) based on the required signal gains (G₁, G₂) so that the total required signal gains (ΣGᵢ) of the determined subset of receivers does not exceed a characteristic of the DCS.

In a further implementation form, the DCS controller is further configured to determine that the total required signal gains (ΣGᵢ) of the determined subset of receivers does not exceed the characteristic of the DCS by determining that the total surface (S*=ΣSᵢ) of the subsets of the scattering elements does not exceed the scattering surface of the DCS.

In a further implementation form, the DCS controller is further configured to determine the subset of receivers based on a Lagrangian optimization solution maximizing a system metric subject to the resources available on the DCS.

The use of the Lagrangian optimization solution implies a simplified computation of the system metric.

In a further implementation form, the system metric is based on the number of users served by the DCS.

In an implementation, the system metric is based on the maximum number of users that can be served by the DCS, simultaneously.

In a further implementation form, the system metric is the throughput being the sum rate of the rate of each user served.

Maximizing the number of co-scheduled user equipments through the DCS results in a maximized throughput.

In a further implementation form, the DCS controller is further configured to determine the subset of receivers based on the Lagrangian optimization by determining an optimal constant (μ*) based on the required Signal-to-Noise-Ratio, SNR, values for the two or more receivers (Rxᵢ), and solving the Lagrangian optimization by moving the optimal constant (μ*) until the total surface of the subsets of the scattering elements reaches the surface of the DCS.

The multiple-user codeword (Cₘ) enables the DCS to serve a subset of the multiple receivers located at different locations, simultaneously.

In a further implementation form, the DCS controller is further configured to determine a scattering pattern focusing on a receiver (Rxᵢ), the scattering pattern corresponding to the pattern of reflection from a perfect electric conductor with the shape of an ellipsoid that has a first focal point (F₁) being the location of a transmitter (Tx) and a second focal point (F₂) being the location of the receiver (Rxᵢ), and wherein the single-user codeword (Cᵢ) is determined based on the scattering pattern.

The use of the ellipsoid to generate the single-user codeword (Cᵢ) leads to simplified computation.

In a further implementation form, the DCS controller is further configured to determine the set of scattering elements for a receiver (Rxᵢ) by determining a first plane containing a main axis of the ellipsoid and that intersects the ellipsoid and determine a first intersect line as the line where the first plane intersects the DCS surface. The DCS controller is further configured to determine a second plane containing the main axis of the ellipsoid and that intersects the ellipsoid and determine a second intersect line as the line where the second plane intersects the DCS surface. The DCS controller is further configured to determine the set of scattering elements for the receiver (Rxᵢ) as a portion of the DCS surface between the first intersect line and the second intersect line.

The determination of the set of scattering elements for the receiver (Rxᵢ) as the portion of the DCS surface between the first intersect line and the second intersect line provides an accurate set of scattering elements.

In a further implementation form, the DCS controller is further configured to translate at least one of the first intersect line and the second intersect line to provide a higher required gain (Gᵢ) for the receiver (Rxᵢ).

By use of the at least one of the first intersect line and the second intersect line, higher gain can be achieved.

In a further implementation form, the DCS controller is further configured to configure the scattering elements of the DCS according to:

$${C}_{i} ( Tx , {Rx}_{i} , DCS ) = \{ {ϕ}_{M}^{i} = \frac{2 π {δ}_{m}}{λ} ≡ \frac{2 π}{λ} ( ‖ \vec{TxM} ‖ + ‖ \vec{{MRx}_{1}} ‖ - ‖ \vec{TxV} ‖ - ‖ \vec{{VRx}_{1}} ‖ ) [ 2 π ] , M ∈ DCS \}$$

wherein
Tx is the location of the transmitter
Rxᵢ is the location of the receiver i
M is the location of a scattering element on the DCS surface
V is the point on the ellipsoid where the line between M and Rxᵢ intersects the ellipsoid
ϕ_{M}ⁱ is the phase shift applied by the DCS at point M
δ_{M} is the path difference between a path through the DCS at point M and other path through an ellipsoid PEC seen at the receiver as coming from the same point M
λ is the wavelength of the emitted signal.

In a further implementation form, the DCS controller is further configured to determine the subset of receivers by receiving scheduling information, indicating which receivers are scheduled to be active, and only determine required signal gains for the receivers that are scheduled to be active.

The reception of the scheduling information reduces the search space for the optimization process. The scheduling information can be adapted according to the requirements at a given instant in time.

In a further implementation form, the DCS controller is further configured to determine the subset of receivers by receiving scheduling information, indicating which receivers are scheduled to be prioritized, and determine the subset of receivers to include the receivers that are to be prioritized.

In a further implementation form, the DCS comprises scattering elements and wherein the DCS controller is further configured to determine the multiple-user codeword (Cₘ) based on the subsets (Sᵢ) of scattering elements by assigning to the scattering elements of subset Sᵢ the phase shift specified by codeword Cᵢ and aggregating these scattering elements and corresponding phase shifts into the multiple-user codeword (Cₘ).

In a further implementation form, a subset (Sᵢ) of the scattering elements of the DCS surface for a receiver (Rxᵢ) consists of contiguous scattering elements.

In a further implementation form, a subset (Sᵢ) of the scattering elements of the DCS surface for a receiver (Rxᵢ) is defined by a stripe having a first angle (a) between two main cutting planes and a second angle (β) representing an opening of the stripe computed (or defined) at the center of the ellipsoid, wherein the first and second angles (α, β) are determined so that the gain (Gᵢ) of the corresponding subset (Sᵢ) is achieved, wherein the width of the stripe reflects a beam width to be used by a transmitter (Tx).

In a further implementation form, a subset (Sᵢ) of the scattering elements of the DCS surface for a receiver (Rxᵢ) consists of non-contiguous scattering elements.

In a further implementation form, the DCS controller further comprises determining the beamformers (Pⁱ) for the transmitter (Tx), the beamformers (Pⁱ) being focused towards the stripe identified for a receiver (Rxᵢ).

In another aspect, the present disclosure provides a method for use in a DCS controller configured to control a DCS to simultaneously serve a subset of the multiple receivers (Rx), the multiple receivers (Rx) comprising at least a first receiver (Rx₁) and a second receiver (Rx₂) being located in different locations, wherein the DCS comprises a plurality of scattering elements arranged on a scattering surface, and where the method comprises determining a single-user codeword (Cᵢ) for each of the multiple receivers (Rxᵢ), wherein a single-user codeword defines the phase configuration for a set of scattering elements of the (scattering) surface of the DCS for the respective receiver (Rxᵢ) and a respective phase shift configuration for each of the scattering elements in the set of scattering elements. The method further comprises determining a required signal gain (Gᵢ) for each of the multiple receivers (Rxᵢ) and determining a subset of receivers (Rx₁, Rx₂) based on the required signal gains (G₁, G₂), wherein the total required signal gains (ΣGᵢ) of the determined subset of receivers does not exceed a characteristic of the DCS. The method further comprises determining a subset (Sᵢ) of scattering elements for each receiver (Rxᵢ) in the subset of receivers (Rx₁, Rx₂), wherein the subset (Sᵢ) for a receiver (Rxᵢ) is determined to satisfy the required signal gain (Gᵢ) for that receiver (Rxᵢ) and subsets (Sᵢ) are disjoint. The method further comprises determining a multiple-user codeword (Cₘ) based on the subsets of scattering elements, wherein the multiple-user codeword (Cₘ) defines the phase configuration for all subsets of scattering elements of the (scattering) surface of the DCS and controlling the DCS based on the multiple-user codeword (Cₘ) for data transmission.

The method achieves all the advantages and technical effects of the DCS controller of the present disclosure.

It has to be noted that all devices, elements, circuitry, units, and means described in the present application could be implemented in the hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity, which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is an environment diagram that illustrates communication between multiple user equipments (MUEs) through a digital controllable scatterer (DCS), in accordance with an embodiment of the present disclosure;

FIG. 2 is a flowchart that illustrates configuration of a DCS to serve multiple user equipments, in accordance with an embodiment of the present disclosure;

FIG. 3 is a diagram that depicts an ellipsoid selection for codeword computation, in accordance with an embodiment of the present disclosure;

FIG. 4 is a diagram that illustrates computation of a set of scattering elements for a receiver, in accordance with an embodiment of the present disclosure;

FIG. 5 is a diagram that depicts computation of a phase shift for scattering elements of a DCS, in accordance with an embodiment of the present disclosure;

FIG. 6 is a diagram that depicts geometric construction of an ellipsoid, in accordance with an embodiment of the present disclosure;

FIG. 7 is a three-dimensional (3D) graphical representation that depicts equivalent points of an ellipsoid emulated by a DCS based on a computed phase shift matrix, in accordance with an embodiment of the present disclosure;

FIG. 8 illustrates mapping of nominal beam directions on a DCS in case of ellipsoid based codewords, in accordance with an embodiment of the present disclosure;

FIG. 9 illustrates computation of a DCS surface allocated to each user equipment, in accordance with an embodiment of the present disclosure;

FIG. 10 is an alternative implementation for computation of a DCS surface allocated to each user equipment, in accordance with another embodiment of the present disclosure;

FIG. 11 is a flowchart of a method for use in a DCS controller, in accordance with an embodiment of the present disclosure;

FIGS. 12A-12C illustrate arrangement of a subset of a plurality of scattering elements of a scattering surface of a DCS, in accordance with different embodiments of the present disclosure; and

FIG. 13 illustrates exemplary configurations of a scattering surface of a DCS, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

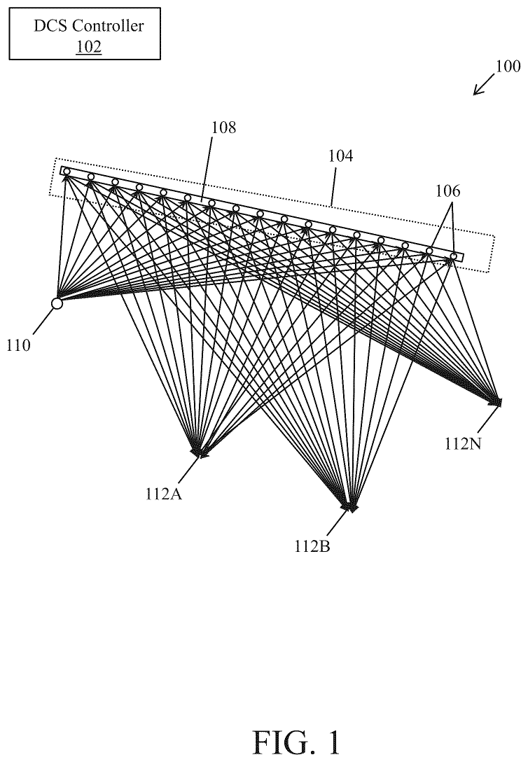

FIG. 1 is an environment diagram that illustrates communication between multiple user equipments (MUEs) through a digital controllable scatterer (DCS), in accordance with an embodiment of the present disclosure. With reference to FIG. 1, there is shown an environment diagram 100 that includes a DCS controller 102 configured to control a DCS 104. The DCS 104 comprises a plurality of scattering elements 106 arranged on a scattering surface 108. There is further shown a transmitter 110 (may also be represented as Tx) and multiple receivers 112, such as a first receiver 112A (may also be represented as Rxᵢ), a second receiver 112B (may also be represented as Rx₂), up to a N-th receiver 112N (may also be represented as Rx_{N}). The DCS 104 is represented by a dashed box which is used for illustration purpose only and does not form a part of circuitry.

The DCS controller 102 may include suitable logic, circuitry, and/or interfaces that is configured to control the DCS 104. Examples of the DCS controller 102 may include, but are not limited to, an integrated circuit, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), and other processors or circuits. Moreover, the DCS controller 102 may refer to one or more individual controllers, controlling devices, a control unit that is part of a machine. In an implementation, the DCS controller 102 may comprise a memory and a network interface as well. The memory may be used to store the generated the multiple-user codewords. Examples of implementation of the memory may include, but are not limited to, Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory. Examples of implementation of the network interface may include, but are not limited to, a communication interface, a computer port, a network socket, a network interface controller (NIC), and any other network interface device. The DCS controller 102 can be located either at a same location or a different location from the location of the DCS 104. Alternatively stated, the DCS controller 102 and the DCS 104 might be or might not be collocated.

The DCS 104 may include suitable logic, circuitry, and/or interfaces that is configured to simultaneously serve each receiver in a subset of the multiple receivers 112 where the subset of receivers is obtained as an outcome of the selection process, that is resource allocation, scheduling constraints, and the like. Each of the multiple receivers 112 are located at different locations. The DCS 104 can be implemented either in form of an Intelligent Reflective Surface (IRS), or a Reflective Intelligent Surface (RIS) or a Large Intelligent Surface (LIS), where the plurality of scattering elements 106 (i.e., a large number of scattering elements), also known as unit elements, are arranged on the scattering surface 108.

The transmitter 110 (i.e., Tx) may include suitable logic, circuitry, and/or interfaces that is configured to transmit a signal-of-interest towards a subset of the multiple receivers 112 simultaneously, by use of the DCS 104. Examples of the transmitter 110 (i.e., Tx) may include, but are not limited to, an Internet-of-Things (IoT) device, a smart phone, a machine type communication (MTC) device, a computing device, an evolved universal mobile telecommunications system (UMTS) terrestrial radio access (E-UTRAN) NR-dual connectivity (EN-DC) device, a server, an IoT controller, a drone, a customized hardware for wireless telecommunication, a transmitter, or any other portable or non-portable electronic device.

Each of the multiple receivers 112 may include suitable logic, circuitry, and/or interfaces that is configured to receive the signal-of-interest transmitted by the transmitter 110 through the DCS 104. Examples of each of the multiple receivers 112 may include, but are not limited to, an Internet-of-Things (IoT) controller, a server, a smart phone, a customized hardware for wireless telecommunication, a receiver, or any other portable or non-portable electronic device. The multiple receivers 112 may also be referred to as multiple user equipments (MUEs) or multiple users.

In operation, the DCS controller 102 is configured to control the digitally controllable scatterer, DCS, 104 to simultaneously serve a subset of the multiple receivers 112 (Rx), the multiple receivers 112 (Rx) comprising at least the first receiver 112A (Rx₁) and the second receiver 112B (Rx₂) being located at different locations, wherein the DCS 104 comprises the plurality of scattering elements 106 arranged on the scattering surface 108. The DCS controller 102 is configured to control the DCS 104 for simultaneously focusing the energy in given areas where the multiple receivers 112 are located. The DCS 104 is divided into sub regions. Each one of these regions is allocated to a given UE and as such are configured using the specific codeword for the intended UE. Additionally, the selected region is nothing else than a set of scattering elements (i.e., the plurality of scattering elements 106). Each of the plurality of scattering elements 106 represents a surface that can be translated into a Radar cross section (RCS) and therefore, a gain factor.

The DCS controller 102 is configured to determine a single-user codeword (Cᵢ) for each of the multiple receivers 112 (Rxᵢ), wherein the single-user codeword defines a set of scattering elements of the (scattering) surface of the DCS 104 for the respective receiver (Rxᵢ) and a respective phase shift configuration for each scattering element in the set of scattering elements. The single-user codeword (Cᵢ) is either selected from a codebook or constructed by following a codeword generation procedure. The codewords are generated for each of the considered UEs (i.e., the subset of the multiple receivers 112) as the single user codewords, that is, as if the UEs are alone. Moreover, the single-user codeword (Cᵢ) is computed for a set of scattering elements arranged on the scattering surface 108 of the DCS 104 for the respective receiver (Rxᵢ). Alternatively, the single-user codeword (Cᵢ) identifies regions of the DCS 104 that are better suited to serve the respective receiver (Rxᵢ) or the user i. Moreover, the single-user codeword defines the respective phase shift configuration for each scattering element in the set of scattering elements. The set of scattering elements and the respective phase shift configuration that is defined by the single-user codeword (Cᵢ) is associated with a gain (Gᵢ) for the i-th UE. Selecting a subset of the set of scattering elements defined by the single-user codeword (Cᵢ) for serving the i-th UE modifies the gain perceived by the i-th UE. This is used for designing the multi-user (MU) codewords.

The DCS controller 102 is further configured to determine a required signal gain (Gᵢ) for each of the multiple receivers 112 (Rxᵢ) and determine a subset of receivers (Rx₁, Rx₂) based on the required signal gains (G₁, G₂). After determining the single-user codewords for each of the multiple receivers 112 (Rxᵢ), nominal directions of the obtained focusing beam is computed and its projection on the DCS 104 is identified based on the single-user codewords. Alternatively stated, a grid of nominal directions for the beam construction identifies subsets of scattering elements for phase shift configuration. The nominal direction may be obtained through the codeword construction and hence, no extra computation would be required. Thereafter, the dimensions of allocated space on the DCS 104 for each of the multiple receivers 112 (Rxᵢ) is identified. Finalizing the allocated space would require identifying the contours of these regions. This boils down to computing the width and height of the parallelogram around the identified nominal direction of the identified most contributing elements. A few constraints are considered for this computation: (i) a first constraint consists in the required gain acquired by virtue of the DCS 104 towards a given UE. This can be clearly translated in terms of the surface that relates directly to the RCS. (ii) A second constraint consists in the DCS constraints (e.g., size of the DCS 104). (iii) A third hidden constraint that is optional but can easily be considered in this framework would be scheduling constraints that can be considered while selecting the codewords that required to be stacked on the DCS 104, simultaneously. This is done based on the required signal gain (Gᵢ) for each of the multiple receivers 112 (Rxᵢ). After evaluating the required signal-to-noise ratio (SNR) for each receiver (or UE) as well as the propagation loss, a link budget can be computed for each of the multiple receivers 112 providing required gains from the DCS 104 in terms of focusing gains. The provided gain is then translated to a surface on the DCS 104. The DCS controller 102 is configured to determine the subset of receivers, for example, the first receiver 112A (i.e., Rxᵢ) and the second receiver 112B (i.e., Rx₂) from the multiple receivers 112 (i.e., Rxᵢ) based on the required signal gains (G₁, G₂).

The DCS controller 102 is further configured to determine a subset (Sᵢ) of scattering elements of the scattering surface 108 for each receiver (Rxᵢ) in the subset of receivers (Rx₁, Rx₂), wherein the subset (Sᵢ) of scattering elements of the scattering surface 108 for a receiver (Rxᵢ) is determined to satisfy the required signal gain (Gᵢ) for that receiver (Rxᵢ) and subsets (Sᵢ) are disjoint. The DCS controller 102 is configured to determine the subset (Sᵢ) of scattering elements from the plurality of scattering elements 106 arranged on the scattering surface 108, for each receiver (Rxᵢ) for the subset of receivers (Rx₁, Rx₂). The subset (Sᵢ) of scattering elements of the scattering surface 108 for each receiver (Rxᵢ) is identified in such a way that the subset (Sᵢ) satisfies the required signal gain (Gᵢ) for each receiver (Rxᵢ). The subset (Sᵢ) of scattering elements of the scattering surface 108 for each receiver (Rxᵢ) are different from each other and have no element in common.

The DCS controller 102 is further configured to determine a multiple-user codeword (Cₘ) based on the subsets, where the multiple-user codeword (Cₘ) defines the phase configuration for all subsets of scattering elements of the scattering surface 108 of the DCS 104 and control the DCS 104 based on the multiple-user codeword (Cₘ) for data transmission. The DCS controller 102 is configured to determine the multiple-user codeword (Cₘ) based on the subsets of scattering elements of the (scattering) surface of the DCS 104 according to Equation (1)

$${C}_{m} = {\sum }_{i = 1}^{K} {1}_{i} ⊙ {C}_{i} \qquad ( 1 )$$

where, 1ᵢ is an indicative function of selected DCS elements for user i and ⊙ is the Hadamard matrix product, K is the total number of users in the selected subset of users, Cᵢ is the single user codeword for user i and Cₘ is the multiple-user codeword which defines the phase configuration for all the subsets of scattering elements of the (scattering) surface of the DCS 104. The DCS controller 102 is further configured to control the DCS 104 based on the multiple-user codeword (Cₘ) for data transmission.

In accordance with an embodiment, the DCS controller 102 is further configured to determine the subset of receivers (Rx₁, Rx₂) based on the single-user codewords (C₁, C₂). The single-user codewords (C₁, C₂) provides a potential configuration state of the set of scattering elements of the DCS 104 and the respective phase shift configuration for each scattering element in the set of scattering elements. The set of scattering elements identifies the better suited regions on the DCS 104 to allocate to each receiver. Therefore, the determination of the subset of receivers (Rx₁, Rx₂) is performed on the basis of the single-user codewords (C₁, C₂).

In accordance with an embodiment, the DCS controller 102 is further configured to determine the subset of receivers (Rx₁, Rx₂) based on the required signal gains (G₁, G₂) so that the total required signal gains (ΣGᵢ) of the determined subset of receivers does not exceed a characteristic of the DCS 104. The total required signal gains (ΣGᵢ) of the determined subset of receivers (i.e., the first receiver 112A (i.e., Rxᵢ) and the second receiver 112B (i.e., Rx₂)) does not exceed the characteristics of the DCS 104. The characteristics of the DCS 104 includes not only the scattering surface 108 but also includes the number of receivers (or user equipments) that can be simultaneously served by the DCS 104, rate at which each receiver (or user equipment) is served and total reflected energy from the DCS 104.

In accordance with an embodiment, the DCS controller 102 is further configured to determine the subset of receivers by receiving scheduling information, indicating which receivers are scheduled to be active, and only determine required signal gains for the receivers that are scheduled to be active. In an implementation, the DCS controller 102 may be configured to receive the scheduling information before determining the required signal gain for each of the multiple receivers 112. The scheduling information indicates which receivers from the multiple receivers 112 are scheduled to be active and then, the DCS controller 102 is configured to determine the required signal gains only for the receivers which are scheduled to be active.

In accordance with an embodiment, the DCS controller 102 is further configured to determine the subset of receivers by receiving scheduling information, indicating which receivers are scheduled to be prioritized, and determine the subset of receivers to include the receivers that are to be prioritized. In an implementation, the scheduling information may include the information about which receivers from the multiple receivers 112 are scheduled to be prioritized. After receiving the scheduling information, the DCS controller 102 is configured to determine the required signal gains only for the receivers which are scheduled to be prioritized.

In accordance with an embodiment, the DCS controller 102 is further configured to determine the multiple-user codeword (Cₘ) based on the subsets of scattering elements by determining the scattering elements of the DCS 104 and corresponding phase shifts for each of the subsets and aggregating these scattering elements and corresponding phase shifts into the multiple-user codeword (Cₘ). The multiple-user codeword (Cₘ) enables focusing required energy towards various users (i.e., the multiple receivers 112 that are required to be served by the DCS 104. In order to generate the multiple-user codeword (Cₘ), followings inputs are considered: (i) a set of codewords or codebooks for serving a single user through the DCS 104, (ii) a set of users (i.e., the multiple receivers 112 that require to be served by the DCS 104, and (iii) the required gains for achieving a communication enabling SNR per considered user. By using aforementioned inputs, the structure of each of the codewords for each receiver is estimated. Thereafter, the resulting structure and the phase shifts are aggregated in order to generate the multiple-user codeword for the subset of the multiple receivers 112 that are required to be served, by the DCS 104. Furthermore, the area to be allocated to each of the codewords in order to achieve the required SNR is computed. The scattering elements to be used by each of the codewords and the corresponding phase shifts are identified.

In accordance with an embodiment, the DCS 104 comprises scattering elements and wherein the DCS controller 102 is further configured to determine the multiple-user codeword (Cₘ) based on the subsets (Sᵢ) of scattering elements by assigning to the scattering elements of each subset of scattering elements (Sᵢ) the phase shift specified by its corresponding single user codeword (Cᵢ) and aggregating these scattering elements (Sᵢ) and the corresponding phase shifts for all subsets of scattering elements into the multiple-user codeword (Cₘ). The DCS 104 comprises the scattering elements (i.e., the plurality of scattering elements 106). The phase shift specified by the single-user codeword Cᵢ is assigned to the scattering elements defined by the subsets (Sᵢ) of scattering elements.

In accordance with an embodiment, the DCS controller 102 is comprised in the DCS 104. In an implementation, the DCS controller 102 may be comprised by the DCS 104. In another implementation, the DCS controller 102 may lie outside the DCS 104.

In accordance with an embodiment, the DCS controller 102 is comprised in a base station. In an implementation, the DCS controller 102 may be used in a communication node. The communication node may be used either as the base station or an access point (AP) in different implementation scenarios.

In accordance with an embodiment, the DCS controller 102 is comprised in a stand-alone device. In an implementation, the DCS controller 102 may be comprised by the base station that may be configured to operate as the stand-alone device. In another implementation, the DCS controller 102 may be comprised by the access point that may be configured to operate as the stand-alone device.

Thus, the DCS controller 102 is configured to control the DCS 104 in such a way that the DCS 104 serves simultaneously a subset of the multiple users while maintaining the required SNR levels for each user. Alternatively stated, the DCS controller 102 is configured to control the DCS 104 based on the multiple-user codeword (Cₘ) which enables the DCS 104 to simultaneously serve the subset of the multiple users by the single multi user codeword Cₘ constructed as the function of the single-user codewords. The DCS controller 102 is configured to generate the single-user codeword using a virtual ellipsoid technique. The single-user codeword is computed for the set of scattering elements of the DCS 104 for each receiver. Thereafter, the DCS controller 102 is configured to determine the required signal gain for each of the multiple receivers 112 and determine the subset of receivers based on the required signal gains. Thereafter, the beam construction is used at the transmitter 110 and used to focus the energy on the allocated DCS elements which further reflects the focused energy towards each of the multiple receivers 112. The generated phase pattern is applied at the various DCS elements and the appropriate or required amount of energy is focused to each of the plurality of served user equipments.

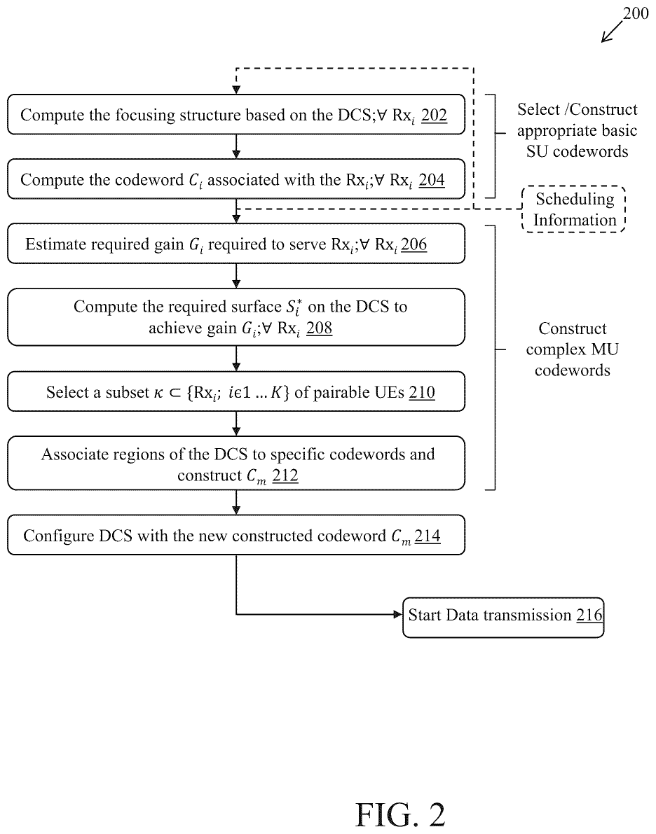

FIG. 2 is a flowchart that illustrates configuration of a DCS to serve a subset of multiple user equipments, simultaneously, in accordance with an embodiment of the present disclosure. FIG. 2 is described in conjunction with elements from FIG. 1. With reference to FIG. 2, there is shown a flowchart 200 that includes steps 220 to 216. The DCS controller 102 (of FIG. 1) is configured to execute the flowchart 200. Moreover, the information (i.e., scheduling information) provided in a dashed box (or dashed lines) is optional and extra useful to enhance the process.

At step 202, a codeword (i.e., a single-user codeword (Cᵢ)) is either selected from a codebook or constructed by following a codeword generation procedure.

At step 204, the codeword is generated for each of the considered UEs (i.e., the subset of the multiple receivers 112) as the single user codewords Cᵢ, that is, as if the UEs are alone.

The steps 202 and 204 are related to either selection or construction of the single user codewords Cᵢ. Before estimating the signal gain required for each of the multiple receivers 112, scheduling information about the multiple receivers 112 is received.

At step 206, based on the generated codeword, the nominal direction of the obtained focusing beam (e.g., radiated beam or scattered beam or an impinging beam) is computed and its projection on the DCS 104 is identified. Thereafter, the signal gain required for each of the multiple receivers 112 is estimated.

At step 208, the dimensions of the allocated space on the DCS 104 for the subset of the multiple receivers 112 is identified based on the estimated gain required for each of the multiple receivers 112.

At step 210, a subset of receivers, for example, the first receiver (i.e., Rxᵢ) 112A and the second receiver (i.e., Rx₂) 112B from the multiple receivers (i.e., Rxᵢ) 112 is determined based on the required signal gains (G₁, G₂).

At step 212, a subset (Sᵢ) of scattering elements from the plurality of scattering elements 106 for each receiver that is Rx₁, and Rx₂ is determined. Furthermore, a multiple-user codeword (Cₘ) based on the single user codewords (Cᵢ) and the subsets (Sᵢ) of scattering elements of the (scattering) surface of the DCS 104 is generated according to Equation (1).

The steps 206 to 212 lead to the generation of the multiple-user codeword (Cₘ).

At step 214, the DCS 104 is configured according to the generated multiple-user codeword (Cₘ). Alternatively stated, the phase profile of the DCS 104 is configured according to the generated multiple-user codeword (Cₘ).

At step 216, data transmission is commenced after configuring the phase configuration of the DCS 104. Alternatively stated, transmitter(s), for example, the transmitter 110 start transmitting the data through the DCS 104 to each of the multiple receivers 112.

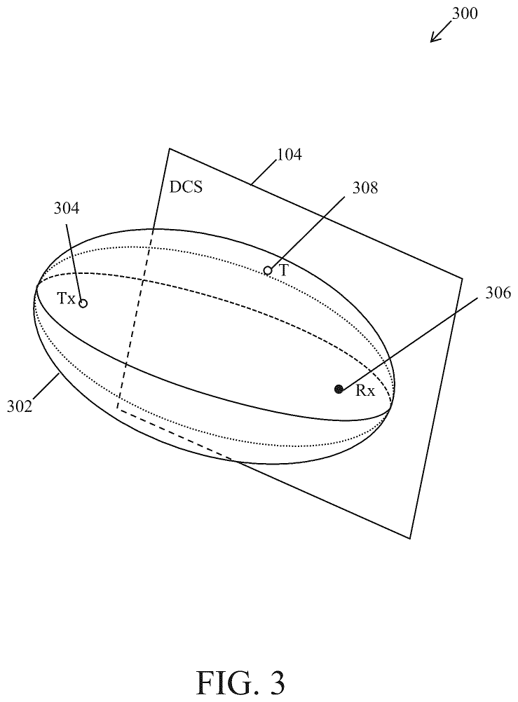

FIG. 3 is a diagram that depicts an ellipsoid selection for codeword computation, in accordance with an embodiment of the present disclosure. FIG. 3 is described in conjunction with elements from FIGS. 1 and 2. With reference to FIG. 3, there is shown a diagram 300 that depicts the ellipsoid selection for the codeword computation that is used for configuration of the DCS 104. There is further shown an ellipsoid 302, a transmitter 304, a receiver 306 and a point T 308 on the ellipsoid 302.

The transmitter 304 corresponds to the transmitter 110 (of FIG. 1). Similarly, the receiver 306 corresponds to one of the multiple receivers 112 (of FIG. 1).

The diagram 300 shows a geometrical construction in which the ellipsoid 302 is selected for its focusing properties. In order to preserve the required focusing capabilities of the ellipsoid 302 (e.g., in three-dimensional, 3D), it is considered that two semi-axes of the ellipsoid 302 that is a semi-minor axis and a semi-third axis have the same size. This consideration along with the tangency condition is for computation simplification as it renders the solution of the construction unique for focusing from the transmitter 304 towards the receiver 306 while not changing the output phase configuration solution up to a Modulo operation. Furthermore, there is shown the transmitter 304 (i.e., Tx) with a focus point F₁, the receiver 306 (i.e., Rx) with a focus point F₂, a plane [symbol] that represents the DCS 104 and the ellipsoid 302 that is tangent to the plane [symbol] . The ellipsoid 302 (may also be represented as unique ellipsoid ε*) is obtained by taking a tangent to the DCS 104 at the point T 308 with F₁ and F₂ as its foci. The ellipsoid 302 is defined with three axes where a main axis is the one connecting two foci points (e.g., F₁ and F₂) is known as a first principal axis. Two secondary axes are also there that are defined in a plane orthogonal to the first principal axis and include the center of the ellipsoid 302. If the two semi-secondary axes are equal then, an ellipsoid of revolution is formed. That means the intersection of any plane with the normal vector \vec{TxRx} with the ellipsoid 302 would provide a circle.

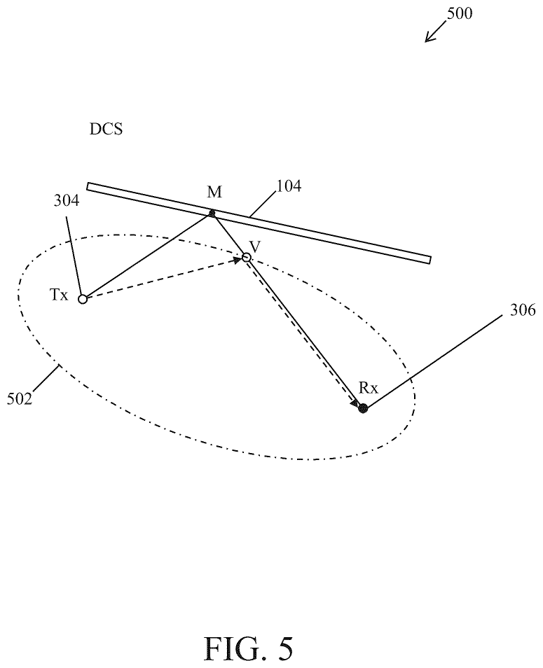

Once the ellipsoid 302 is constructed, the codeword computation can be started. The energy from the transmitter 304 to the receiver 306 can be focused with a perfect electric conductor that has the shape of the designed ellipsoid 302. Therefore, the DCS 104 is configured in such a way that the scattering pattern of the DCS 104 mimics the pattern of reflection from the perfect electric conductor with the shape of the ellipsoid 302 (i.e., optimal constructed ellipsoid) and thus the DCS 104 acquires all its focusing properties (i.e., the focusing properties of the ellipsoid 302). Thus, mapping the behavior of reflection from the perfect electric conductor with the shape of the ellipsoid 302 to the scattering from the DCS 104 boils down to providing the phase shift configuration of the DCS 104 that results in the correct (i.e., the exact same) path difference for each point of the DCS 104, described in detail, for example, in FIG. 5. Alternatively stated, for each of the controllable elements of the DCS 104, the correct path difference is applied as a phase shift in such a way that the path difference via the DCS 104 matches the one that is observed through the ellipsoid 302.

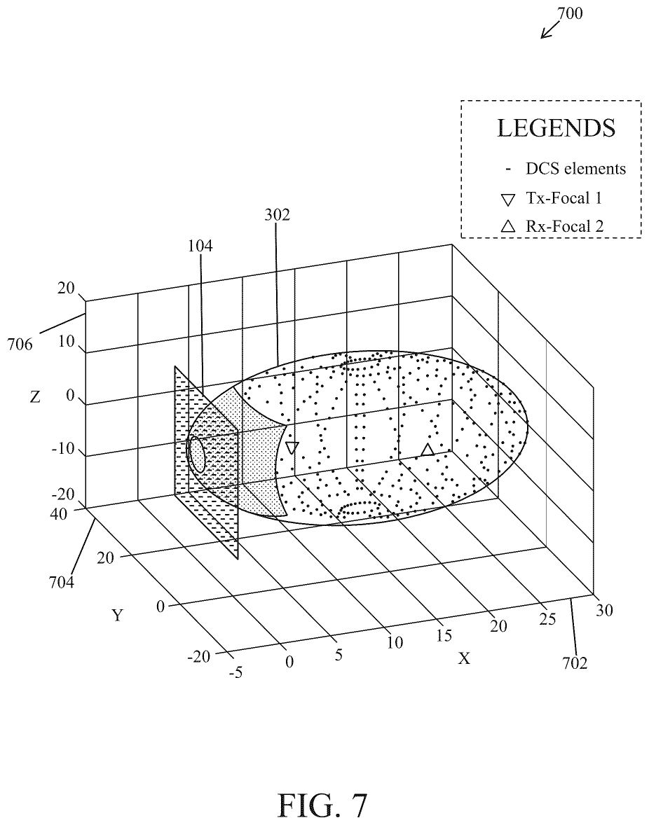

The specific construction procedure of the codewords is described in detail, for example, in FIG. 7. The set of constructed or computed codewords spanning the considered space compose the codebook. The codebook is a structured partially ordered set (poset) by construction and can directly be ordered with an absolute or relative distance measure in space (i.e., related to coordinates in three dimensions). Since the construction of codewords is geometrical based, the codeword can be obtained as an analytical solution in function to the relative position of the transmitter 304, the receiver 306 and the DCS 104. And therefore, only one expression (e.g., a mathematical expression) is required to be stored by a system.

In accordance with an embodiment, the DCS controller 102 is further configured to determine a scattering pattern focusing on a receiver (Rxᵢ), the scattering pattern corresponding to the pattern of reflection from a perfect electric conductor with the shape of an ellipsoid that has a first focal point (F₁) being the location of a transmitter (Tx) and a second focal point (F₂) being the location of the receiver (Rxᵢ), and wherein the single-user codeword (Cᵢ) is determined based on the scattering pattern. The scattering pattern corresponds to the pattern due to reflection from the perfect electric conductor that has the shape of the ellipsoid (e.g., the ellipsoid 302). The ellipsoid 302 is tangent to the plane of the DCS 104 (as shown in FIG. 3). The ellipsoid 302 has the first focal point (F₁) as the location of the transmitter 304 and the second focal point (F₂) as the location of the receiver 306. Moreover, the single-user codeword (Cᵢ) associated to each receiver is determined based on the scattering pattern, described in detail, for example, in FIG. 5.

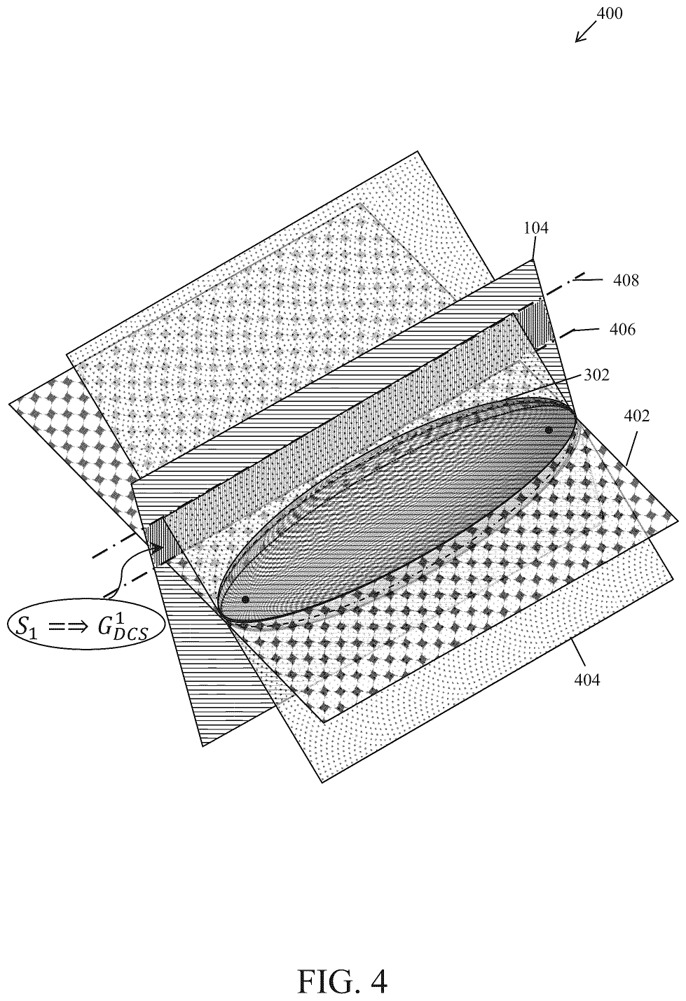

FIG. 4 is a diagram that illustrates computation of a set of scattering elements for a receiver, in accordance with an embodiment of the present disclosure. FIG. 4 is described in conjunction with elements from FIGS. 1, 2 and 3. With reference to FIG. 4, there is shown a diagram 400 that depicts computation of a set of scattering elements for a receiver (e.g., the receiver 306 of FIG. 3). There is further shown a first plane 402, a second plane 404, a first intersect line 406 and a second intersect line 408.

In accordance with an embodiment, the DCS controller 102 is further configured to determine the set of scattering elements for the receiver 306 (Rxᵢ) by determining the first plane 402 containing a main axis of the ellipsoid 302 and that intersects the ellipsoid 32. The DCS controller 102 is further configured to determine the first intersect line 406 as the line where the first plane 402 intersects the DCS 104 surface and determine the second plane 404 containing the main axis of the ellipsoid 302 and that intersects the ellipsoid 32. The DCS controller 102 is further configured to determine the second intersect line 408 as the line where the second plane 404 intersects the DCS 104 surface and determine the set of scattering elements for the receiver 306 (Rxᵢ) as a portion of the DCS 104 surface between the first intersect line 406 and the second intersect line 408. The diagram 400 illustrates the construction of ellipsoids for the receiver 306 and thereafter, the set of scattering elements for the DCS 104 is computed. For this computation, the DCS controller 102 is configured to consider the first plane 402 containing the main axis of the ellipsoid 302 and the first plane 402 intersects the ellipsoid 302. Thereafter, the DCS controller 102 is configured to determine the first intersect line 406 where the first plane 402 intersects the DCS 104. The DCS 104 is represented as a planar structure. The DCS controller 102 is configured to consider the second plane 404 containing the main axis of the ellipsoid 302 and the second plane 404 intersects the ellipsoid 302. Thereafter, the DCS controller 102 is configured to determine the second intersect line 408 where the second plane 404 intersects the DCS 104. The second plane 404 is different from the first plane 402. The portion of the DCS 104 surface between the first intersect line 406 and the second intersect line 408 is used by the DCS controller 102 to determine the set of scattering elements for the receiver 306. Alternatively stated, the portion of the DCS 104 surface between the first intersect line 406 and the second intersect line 408 is used to focus the energy towards the receiver 306.

In accordance with an embodiment, the DCS controller 102 is further configured to translate at least one of the first intersect line 406 and the second intersect line 408 to provide a higher required gain (Gᵢ) for the receiver 306 (Rxᵢ). The DCS controller 102 is configured to translate the area of at least one of the first intersect line 406 and the second intersect line 408 to provide the higher required gain (may also be represented as Sᵢ=⇒G_{DCS}ⁱ) for the receiver 306. The higher required gain may be achieved by changing the angle between the first plane 402 and the second plane 404 around the main axis of the ellipsoid 302.

FIG. 5 is a diagram that depicts computation of a phase shift for scattering elements of a DCS, in accordance with an embodiment of the present disclosure. FIG. 5 is described in conjunction with elements from FIGS. 1, 2, 3 and 4. With reference to FIG. 5, there is shown a diagram 500 that depicts computation of the phase shift for the scattering elements of the DCS 104 (of FIG. 1). There is further shown an ellipse 502.

In the diagram 500, a structured codeword based on the ellipsoid 302 is used for encoding the phase shifts of the DCS 104 for focusing between a transmitter 304 and a receiver 306. For a different Rx, a different codeword is computed. The different single user codewords constitute the structured single user codebook (codebook where a codeword is designed to serve only one user at a time) as a partially ordered set with respect to the focusing metric. In the diagram 500, the codewords are related to a spatial positioning of the foci points. The codewords are therefore generated through a construction based, on emulating the behaviour of an ellipsoid of revolution (e.g., the ellipsoid 302). That is, two semi-secondary axes have same size. The ellipsoid 302 can also be constructed by rotating an ellipse around its main axis. For simplicity, the ellipsoid 302 (i.e., ε*) is selected that is tangent to the DCS 104 and the ellipsoid 302 simplifies the expressions for the codes. The construction of the ellipsoid 302 may be performed in two ways, first one is analytical where the parameters of the ellipsoid 302 are provided and second one is geometrical. Based on the ellipsoid 302 (i.e., ε*), the phase shifts for various elements of the DCS 104 are computed. In an implementation, a point M is shown (in the diagram 500) on the DCS 104 that is located at the center of the scattering elements of the DCS 104. Furthermore, an ellipse E is constructed as the intersection of the plane (TₓM Rₓ) with the ellipsoid 302 (i.e., ε*) represented in dash-dotted line 502 in FIG. 5. Thereafter, the DCS controller 102 computes the phase at the receiver 306 of a signal that propagates from the transmitter 304 to the receiver 306 via a ray bouncing at the point M on the DCS 104. The ray that is reflected from the DCS 104, is represented as MRx, (i.e., on the point M), and intersects the ellipse E at a point V. The reflected ray from the ellipsoid 302 is plotted as a dashed line VRx. In order to ensure for the DCS 104 to mimic the reflecting behavior of the ellipsoid 302 and acquire the focusing properties, both the paths TₓV Rₓ and TₓM Rₓ should present the same phase. In order to achieve the same phase, the phase at point M of the DCS 104 is required to be compensated by the following path difference, as shown in Equation (2):

$${ϕ}_{M} = \frac{2 {πδ}_{m}}{λ} ≡ \frac{2 π}{λ} ( ‖ \vec{TxM} ‖ + ‖ \vec{MRx} ‖ - ‖ \vec{TxV} ‖ - ‖ \vec{VRx} ‖ ) [ 2 π ] \qquad ( 2 )$$

In accordance with an embodiment, the DCS controller 102 is further configured to configure the scattering elements of the DCS 104 according to:

$${C}_{i} ( Tx , {Rx}_{i} , DCS ) = \{ {ϕ}_{M}^{i} = \frac{2 π {δ}_{m}}{λ} ≡ \frac{2 π}{λ} ( ‖ \vec{TxM} ‖ + ‖ \vec{{MRx}_{ι}} ‖ - ‖ \vec{TxV} ‖ - ‖ \vec{{VRx}_{ι}} ‖ ) [ 2 π ] , M ∈ DCS \}$$

wherein
Tx is the location of the transmitter 304
Rxᵢ is the location of the receiver i 306
M is the location of a scattering element on the DCS 104 surface
V is the point on the ellipsoid 302 where the line between M and Rxᵢ intersects the ellipsoid 302
ϕ_{M}ⁱ is the phase shift applied by the DCS at point M
δ_{M} is the path difference between a path through the DCS 104 at point M and other path through an ellipsoid PEC seen at the receiver 306 as coming from the same point M λ is the wavelength of the emitted signal.

All these quantities are geometrically constructed and can be computed as closed form expressions as a function of the coordinates of Tx, Rx and M and a definition of the DCS 104 plane. The resulting phase per scattering element is computed by computation of the path difference δ_{M} for all the points M that corresponds to the center of the scattering elements of the DCS 104. The obtained codeword is defined as the set given by Equation (3)

$$c ( Tx , Rx , DCS ) = \{ {ϕ}_{M} , M ∈ DCS \} \qquad ( 3 )$$

Finally, the codebook is an aggregation of all codewords for given positions of the transmitter 304 and the receiver 306 in the region of interest.

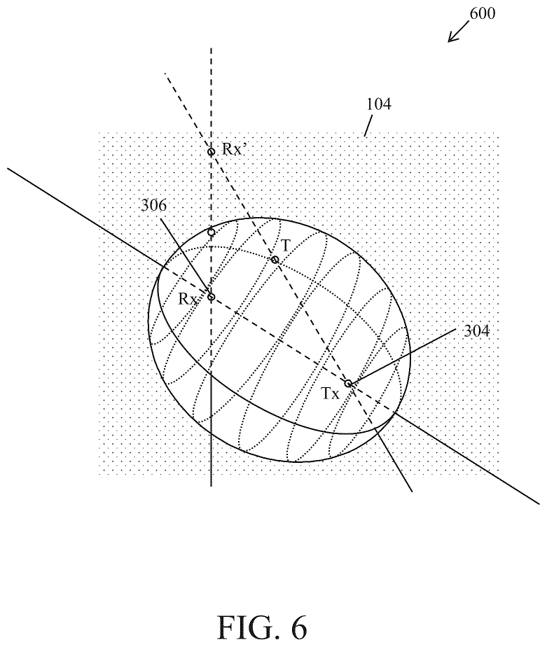

FIG. 6 is a diagram that depicts geometric construction of an ellipsoid, in accordance with an embodiment of the present disclosure. FIG. 6 is described in conjunction with elements from FIGS. 1, 2, 3, 4 and 5. With reference to FIG. 6, there is shown a diagram 600 that depicts geometric construction of an ellipsoid (e.g., the ellipsoid 302 of FIG. 3).

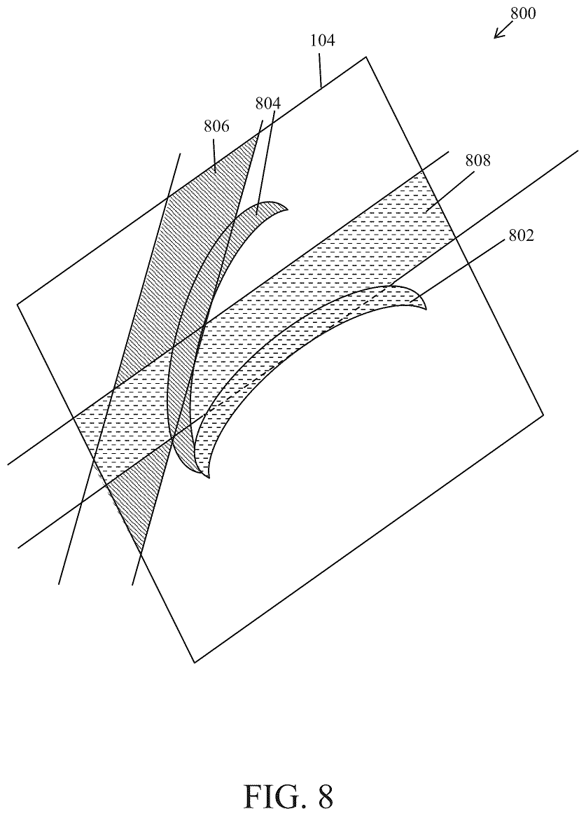

The diagram 600 illustrates geometric construction of the ellipsoid of revolution (i.e., the ellipsoid 302) that is tangent to a plane surface (e.g., the DCS 104) with specific foci points of the transmitter 304 (i.e., Tₓ) and the receiver 306 (i.e., Rₓ). Alternatively stated, the diagram 600 illustrates a geometrical method of constructing the ellipsoid of revolution (i.e., the ellipsoid 302) based on simple geometrical operations. The construction procedure is as follows: at first, a symmetric point Rx′ of the receiver 306 (i.e., Rx) is constructed with respect to the plane of the DCS 104. Thereafter, a line Rx′Tx is considered and a point T is considered at the intersection of the line Rx′Tx with the plane of the DCS 104. The point T is then the tangent point of the ellipsoid 302 with the plane of the DCS 104. Finally, the ellipse is constructed with foci points Rx and Tx and passing through the point T. And the ellipsoid 302 is constructed simply by rotating the ellipse around its main axis (i.e., Rx′Tx). The construction procedure is illustrated in detail, for example, in FIG. 8.

In addition to the geometric construction of the ellipsoid 302 an analytical approach may also be used for the construction of the ellipsoid 302. All geometrical operations can be converted to their analytical equivalent where the application of the geometrical operations to the coordinates of considered points provides an analytical expression of the ellipsoid 302.

FIG. 7 is a three-dimensional (3D) graphical representation that depicts equivalent points of an ellipsoid emulated by a DCS based on a computed phase shift matrix, in accordance with an embodiment of the present disclosure. FIG. 7 is described in conjunction with elements from FIGS. 1, 2, 3, 4, 5 and 6. With reference to FIG. 7, there is shown a 3D graphical representation 700 that depicts the equivalent points of an ellipsoid (e.g., the ellipsoid 302 of FIG. 3) emulated by the DCS 104 based on the computed phase shift matrix.

With reference to FIG. 7, there is shown the 3D graphical representation 700 that includes an X-axis 702, a Y-axis 704 and a Z-axis 706 that are used to represent the equivalent points of the ellipsoid 302 that is emulated by the DCS 104 based on the computed phase shift matrix.

In accordance with an embodiment, the DCS controller 102 is configured to select at least one of the single-user codewords (Cᵢ) from stored single-user codewords. In an implementation, the codebook is considered as a fixed one where specific points in space have been preselected. In such case, an area that is planned to be covered by the DCS 104 is computed. Hence, for each of the points, the state of the DCS 104 is computed and stored. The codebook would then be a lookup table or a 2D matrix of size S×| [symbol] | where S is the number of scattering elements on the DCS 104 and | [symbol] | is the cardinality of the codebook that is the number of relevant points considered in the area.

In accordance with an embodiment, the DCS controller 102 is configured to construct at least one of the single-user codewords (Cᵢ). In an implementation, the codebook (i.e., the structured codebook) may be constructed using an explicit equation form of the ellipsoid 302 which will compress the description of the codebook to the description of the ellipsoid equation. In such case, the closed form expression is used to generate the codeword for a given point in space simply by substituting the coordinates of a targeted point and coordinates of a foci, such as the foci of the transmitter 304 (or the foci of the receiver 306).

As described in FIG. 6, the closed form expression of the tangent ellipsoid is obtained. And, the coordinates of the two foci points and the equation defining the plane of the DCS 104 is obtained which is used to compute the path difference for each scattering element M (x_{M}, y_{M}, z_{M}) of the DCS 104 and update the phase shift correction ϕ_{M} to be applied. The closed form expression of the codeword for any foci points in space and any point on the DCS 104 is defined by the corresponding Cartesian expression as given in Equation (4).

$${ϕ}_{M} = f ( Tx , Rx , 𝒫 , M ∈ 𝒫 ) \qquad ( 4 )$$

Using the closed form expression, the codebook requires no more storage or lookup tables as the value of the codeword could be instantaneously computed over the set of scattering elements M constituting the DCS 104. Furthermore, the codeword computation can be simplified by considering real-world deployment scenario and the underlying assumptions. Indeed, the DCS 104 plane as well as one of the foci points (generally Tx) can be assumed known and fixed and as such the codewords are simply a function of the receiving point in space. The various points considered on the DCS 104 as reflecting elements are predefined as fixed components on the DCS 104 according to Equation (5)

$${ϕ}_{M} = f ( Rx ) \qquad ( 5 )$$

FIG. 8 illustrates mapping of nominal beam directions on a DCS in case of ellipsoid based codewords, in accordance with an embodiment of the present disclosure. FIG. 8 is described in conjunction with elements from FIGS. 1, 2, 3, 4, 5, 6, and 7. With reference to FIG. 8, there is shown an illustration 800 that depicts mapping of nominal beam directions on the DCS 104 in case of the ellipsoid 302 based codewords. In the illustration 800, there is shown a first set 806 identified for a first receiver Rxᵢ and a second set 808 identified for a second receiver Rx₂ on the DCS 104. There is further shown a surface 804 which is defined by an intersection of the ellipsoid computed for Rxᵢ and the chosen cutting planes 402 and 404 for Rxᵢ as depicted in FIG. 4. Also, shown another surface 802 which is defined by the intersection of the ellipsoid computed for Rx₂ and a second set of cutting planes chosen for Rx₂.

In the illustration 800, the single user codebook constructed in FIG. 7, is used to compute the multiple-user codeword. In this case, the representation of the codewords' nominal direction as seen at the DCS 104 is very simple. By construction, this is provided by the DCS 104 plane passing through the transmitter 304, the receiver 306 and tangent to the tangent point of the ellipsoid 302 with the DCS 104. The obtained geometric structure is a line. A numerical opening around the nominal direction as highlighted by a subset of the ellipsoid 302 is considered in the illustration 800. The projection of the beam opening around the nominal direction provides the highlighted stripes as shown in the illustration 8Q The intersection of these stripes with the DCS 104 provides a range of achievable gains.

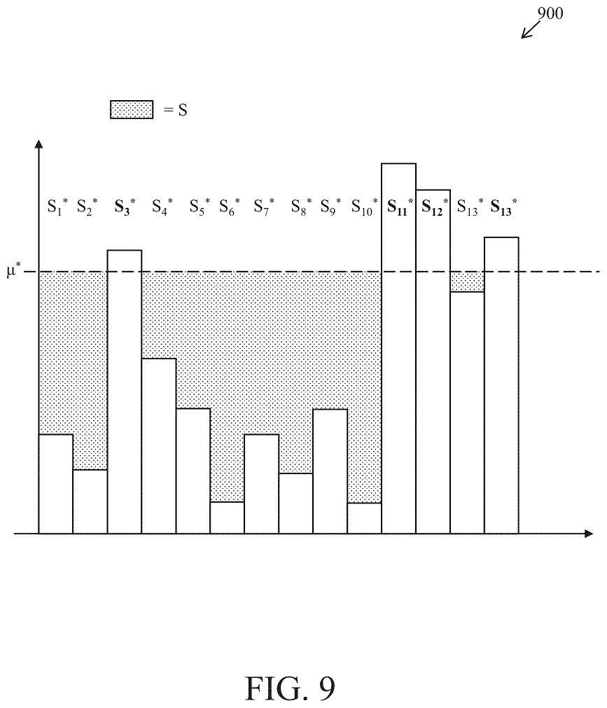

FIG. 9 illustrates computation of a DCS surface allocated to each user equipment, in accordance with an embodiment of the present disclosure. FIG. 9 is described in conjunction with elements of FIGS. 1, 2, 3, 4, 5, 6, 7, and 8. With reference to FIG. 9, there is shown a bar graph 900 that illustrates computation of the surface on the DCS 104 that is allocated to each receiver (or user equipment).

In accordance with an embodiment, the DCS controller 102 is further configured to determine that the total required signal gains (ΣGᵢ) of the determined subset of receivers does not exceed the characteristic of the DCS 104 by determining that the total surface (S*=ΣSᵢ) of the subsets of the scattering elements does not exceed the scattering surface of the DCS 104. The subset of receivers (i.e., the first receiver 112A (Rxᵢ) and the second receiver 112B (Rx₂)) is determined in such a way that the total required gains (ΣGᵢ) of the subset of receivers does not exceed the characteristics of the DCS 104. The characteristics of the DCS 104 have been described in detail, for example, in FIG. 1. Moreover, the total surface (S*=ΣSᵢ) of the subsets of the scattering elements associated to the subset of receivers does not exceed the scattering surface (i.e., the scattering surface 108) of the DCS 104. The scattering surface 108 of the DCS 104 is associated to the multiple-users.

In accordance with an embodiment, the DCS controller 102 is further configured to determine the subset of receivers based on a Lagrangian optimization solution maximizing a system metric subject to the resources available on the DCS 104. The subset of receivers (i.e., the first receiver 112A (Rxᵢ) and the second receiver 112B (Rx₂)) is determined based on the Lagrangian optimization solution under maximization of the system metric subject to the required area requirement and constraints.

In accordance with an embodiment, the system metric is based on the number of users served by the DCS 104. In an implementation, the system metric may be defined as the maximum number of receivers (or users) that can be served simultaneously through the DCS 104.

In accordance with an embodiment, the system metric is the throughput being the sum rate of the rate of each user served. In an implementation, the system metric may be defined as maximizing the throughput in terms of maximizing the sum rate of the rate at which each user is served by the DCS 104.

A potential implementation of the optimization starts by considering for each UE (Rxᵢ): (i) an associated codeword (i.e., the single user codeword, Cᵢ) and a potential configuration state of the elements of the DCS 104, (ii) a required gain, Gᵢ, that is required to enable communication or can be considered as a quality of service (QoS) and proportional to a surface Gᵢ=αSᵢ. Finding the set of pairable UEs boils down to coloring the DCS 104 under the constraint of available resources (i.e., the surface S of the DCS 104). The problem can then be formulated as a standard optimization problem. Fora maximum sum rate (Max-SR) criteria and after writing down the KKT, the following conditions are obtained in the form of Equation (6)

$$\{ \begin{matrix}{S}_{i}^{*} = {( μ - \frac{1}{{s}_{i}} )}^{+} \\ {\sum }_{i} {S}_{i}^{*} \leq S\end{matrix} \qquad ( 6 )$$

In accordance with an embodiment, the DCS controller 102 is further configured to determine the subset of receivers based on the Lagrangian optimization by determining an optimal constant (μ*) based on the required Signal-to-Noise-Ratio, SNR, values for the two or more receivers (Rxᵢ), and solving the Lagrangian optimization by moving the optimal constant (μ*) until the total surface of the subsets of the scattering elements reaches the surface of the DCS 104. The computation of the Lagrangian optimization provides the optimal constant (μ*) that is required to be computed based on the required SNR values for the two or more receivers (Rxᵢ) and as a function of the allocated surface on the DCS 104. The solution to the Lagrangian optimization is obtained by moving the optimal constant (μ*) and computing the surface until the surface reaches the total surface (i.e., available resources) of the DCS 104. The shaded portion in the FIG. 9 highlights the surface allocated to each UE.

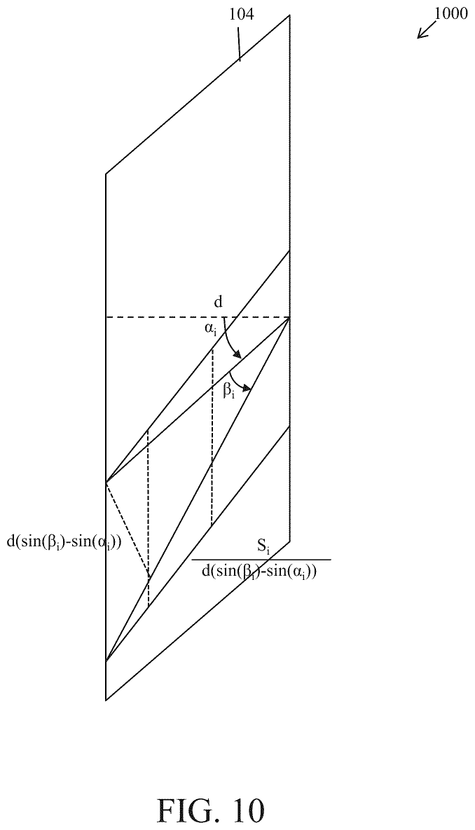

FIG. 10 is an alternative implementation for computation of a DCS surface allocated to each user equipment, in accordance with another embodiment of the present disclosure. FIG. 10 is described in conjunction with elements of FIGS. 1, 2, 3, 4, 5, 6, 7, 8, and 9. With reference to FIG. 10, there is shown a diagram 1000 that illustrates the DCS 104 as a plane.

In accordance with an embodiment, a subset (Sᵢ) of the scattering elements of the DCS 104 surface for a receiver (Rxᵢ) consists of contiguous scattering elements. As illustrated in FIG. 9, a set of UE s that can be served at the same time by the DCS 104 can be written in form of Equation (7)

$$κ = \{ {Rx}_{i} ; i ∈ 1 … K \vert {S}_{i}^{*} > 0 \} \qquad ( 7 )$$

and the subset of scattering elements (i.e., associated required surfaces) associated to the set of UEs is Sᵢ*∀Rxᵢ∈κ. Alternatively stated, the subset (Sᵢ) of the scattering elements of surface of the DCS 104 for the receiver (Rxᵢ), for example, the receiver 306 of FIG. 3, consists of contiguous scattering elements.

In accordance with an embodiment, a subset (Sᵢ) of the scattering elements arranged on the scattering surface 108 of the DCS 104 for a receiver (Rxᵢ) is defined by a stripe having a first angle (α) between two main cutting planes and a second angle (β) representing an opening of the stripe computed (or defined) at the center of the ellipsoid (e.g., the ellipsoid 302), wherein the first and second angles (α, β) are determined so that the gain (Gᵢ) of the corresponding subset (Sᵢ) is achieved, wherein the width of the stripe reflects a beam width to be used by a transmitter (Tx). The zones on the DCS 104 are divided into stripes with the first angle (α) between two main cutting planes and the second angle (β) representing the opening of the stripe computed (or defined) at the center of the ellipsoid (e.g., the ellipsoid 302). The stripes can therefore be controlled by use of the first angle (α) and the second angle (β).

In accordance with an embodiment, a subset of the scattering elements of the DCS surface for a receiver (Rxᵢ) consists of non-contiguous scattering elements. In an implementation, the subset of the scattering elements of surface of the DCS 104 for the receiver (Rxᵢ) consists of non-contiguous scattering elements.

In accordance with an embodiment, comprising determining the beamformers (Pⁱ) for the transmitter (Tx), the beamformers (Pⁱ) being focused towards the stripe identified for a receiver (Rxᵢ). The width of the area can then be chosen as to fulfil the Sᵢ condition and reflects the beam width used at the transmitter 304. The obtained problem is then a packing problem of parallelogram with variable sizes.

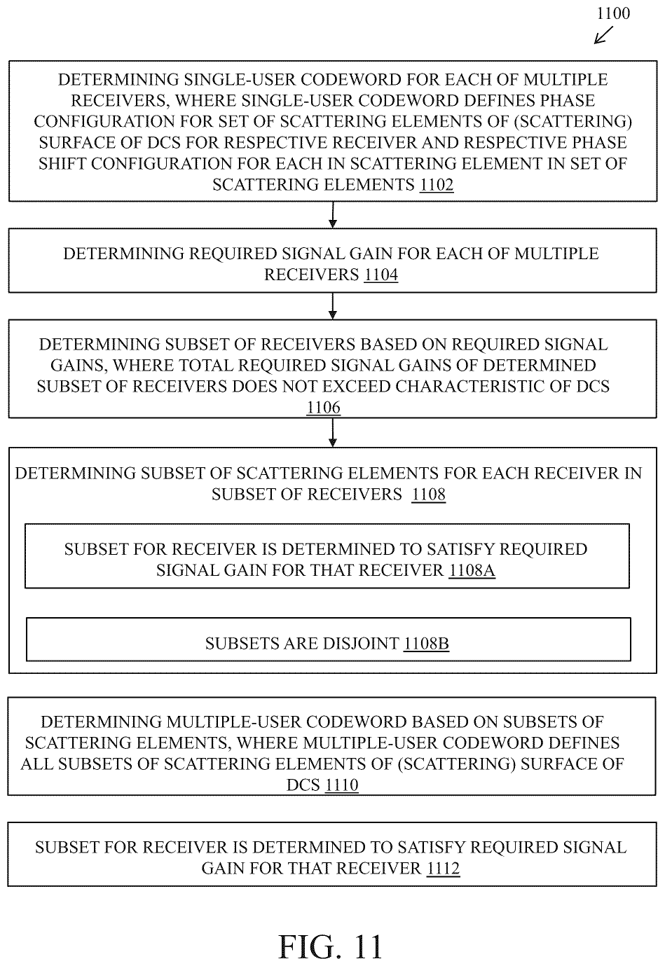

FIG. 11 is a flowchart of a method for use in a DCS controller, in accordance with an embodiment of the present disclosure. FIG. 11 is described in conjunction with elements from FIGS. 1, 2, 3, 4, 5, 6, 7, 8, 9, and 10. With reference to FIG. 11, there is shown a method 1100 that includes steps 1102 to 1112. The step 1108 includes two sub-steps 1108A and 1108B. The method 1100 is executed by the DCS controller 102 (of FIG. 1).

There is provided the method 1100 for use in the DCS controller 102 configured to control the DCS 104 to simultaneously serve a subset of the multiple receivers 112 (Rxᵢ), the multiple receivers 112 (Rxᵢ) comprising at least a first receiver 112A (Rx₁) and a second receiver 112B (Rx₂) being located in different locations, wherein the DCS 104 comprises the plurality of scattering elements 106 arranged on the scattering surface 108. The DCS controller 102 is configured to control the DCS 104 for simultaneously focusing the energy in given areas where simultaneously served receivers (i.e., the subset) from the multiple receivers 112 are located. The DCS 104 is divided into sub regions. Each one of these regions is allocated to a given UE and as such are configured using the specific codeword for the intended UE.

At step 1102, the method 1100 comprises determining a single-user codeword (Cᵢ) for each of the multiple receivers (Rxᵢ), wherein a single-user codeword defines the phase configuration for a set of scattering elements of the (scattering) surface of the DCS 104 for the respective receiver (Rxᵢ) and a respective phase shift configuration for each scattering element in the set of scattering elements. The single-user codeword (Cᵢ) is either selected from a codebook or constructed by following a codeword generation procedure. The codewords are generated for each of the considered UEs (i.e., the multiple receivers 112) as the single user codewords, that is, as if the UEs are alone, described in detail, for example, in FIG. 1.

At step 1104, the method 1100 further comprises determining a required signal gain (Gᵢ) for each of the multiple receivers 112 (Rxᵢ). After determining the single-user codewords for each of the multiple receivers (Rx) 112, nominal directions of the obtained focusing beam is computed and its projection on the DCS 104 is identified based on the single-user codewords. Thereafter, the dimensions of allocated space on the DCS 104 for each of the multiple receivers 112 (Rxᵢ) is identified. This is done based on the required signal gain (Gᵢ) for each of the multiple receivers (Rxᵢ) 112. After evaluating the required signal-to-noise ratio (SNR) for each receiver (or UE) as well as the propagation loss, a link budget can be computed for each of the multiple receivers 112 providing required gains from the DCS 104 in terms of beamforming gains. The provided gain is then translated to a surface on the DCS 104.

At step 1106, the method 1100 further comprises determining a subset of receivers (Rx₁, Rx₂) based on the required signal gains (G₁, G₂), wherein the total required signal gains (ΣGᵢ) of the determined subset of receivers does not exceed a characteristic of the DCS 104. The DCS controller 102 is configured to determine the subset of receivers, for example, the first receiver 112A (i.e., Rxᵢ) and the second receiver 112B (i.e., Rx₂) from the multiple receivers 112 (i.e., Rx) based on the required signal gains (G₁, G₂).

At step 1108, the method 1100 further comprises determining a subset (Sᵢ) of scattering elements for each receiver (Rxᵢ) in the subset of receivers (Rx₁, Rx₂). The DCS controller 102 is configured to determine the subset (Sᵢ) of scattering elements from the plurality of reflective elements 108 arranged on the scattering surface 108, for each receiver (Rxᵢ) for the subset of receivers (Rx₁, Rx₂).

At sub-step 1108A, the step 1108 comprises the subset (Sᵢ) for a receiver (Rxᵢ) is determined to satisfy the required signal gain (Gᵢ) for that receiver (Rxᵢ). The subset (Sᵢ) of scattering elements of the scattering surface for each receiver (Rxᵢ) is identified in such a way that the subset (Sᵢ) satisfies the required signal gain (Gᵢ) for each receiver (Rxᵢ).

At sub-step 1108B, the step 1108 comprises subsets (Sᵢ) are disjoint. The subset (Sᵢ) of scattering elements of the scattering surface for each receiver (Rxᵢ) are different from each other and have no element in common.

At step 1110, the method 1100 further comprises determining a multiple-user codeword (Cₘ) based on the subsets of scattering elements, wherein the multiple-user codeword (Cₘ) defines all subsets of scattering elements of the scattering surface of the DCS 104. The DCS controller 102 is configured to determine the multiple-user codeword (Cₘ) based on the subsets of scattering elements of the (scattering) surface of the DCS 104 according to the equation (1), described in detail, for example, in FIG. 1.

At step 1112, the method 1100 further comprises controlling the DCS 104 based on the multiple-user codeword (Cₘ) for data transmission. The multiple-user codeword (Cₘ, may also be denoted as C_{MU}) defines the phase configuration for all the subsets of scattering elements of the (scattering) surface of the DCS 104. The DCS controller 102 is further configured to control the DCS 104 based on the multiple-user codeword (Cₘ) for data transmission.

The steps 1102 to 1112 (along with the sub-steps 1108A to 1108B) are only illustrative, and other alternatives can also be provided where one or more steps are added, one or more steps are removed, or one or more steps are provided in a different sequence without departing from the scope of the claims herein.

In one aspect, a computer program product comprising program instructions for performing the method 1100, when executed by one or more processors in the DCS controller 102. In another aspect, the computer program product comprising a non-transitory storage medium on which the program instructions are stored.

There is provided, a computer program product comprising a non-transitory storage medium having computer-readable codes means are stored. In such an embodiment, the computer program product comprising computer-readable code, which, when run in the DCS controller 102 causes the DCS controller 102 to perform the method 1100. The computer program product may be implemented as an algorithm, embedded in a software stored in the non-transitory computer-readable storage medium. The non-transitory computer-readable storage means may include but are not limited to, an electronic storage device, a magnetic storage device, an optical storage device, an electromagnetic storage device, a semiconductor storage device, or any suitable combination of the foregoing. Examples of implementation of computer-readable storage medium, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer-readable storage medium, and/or CPU cache memory.

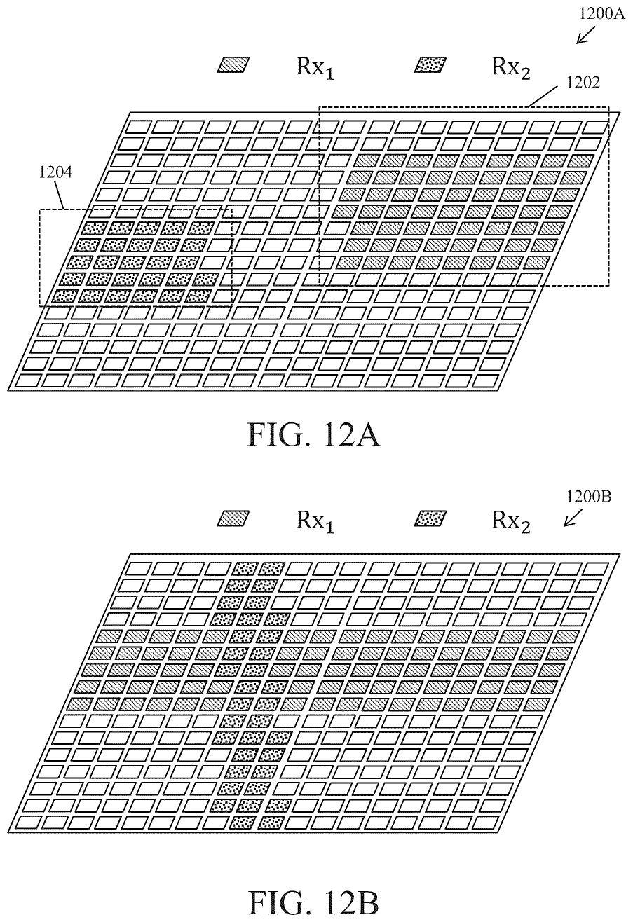

FIGS. 12A-12C illustrate arrangement of a subset of a plurality of scattering elements of a scattering surface of a DCS, in accordance with different embodiments of the present disclosure. FIGS. 12A-12C are described in conjunction with elements from FIGS. 1, 2, 3, 4, 5, 6, 7, 8, 9, 10, and 11. With reference to FIG. 12A, there is shown an illustration 1200A that depicts a subset of the plurality of scattering elements 106 of the scattering surface 108 of the DCS 104 for the first receiver 112A (i.e., Rxᵢ), and the second receiver 112B (i.e., Rx₂) consists of contiguous scattering elements. For example, each of a first dashed box 1202 and a second dashed box 1204 illustrates that the subset of the plurality of scattering elements 106 of the scattering surface 108 of the DCS 104 for the first receiver 112A (i.e., Rxᵢ), and the second receiver 112B (i.e., Rx₂) consists of contiguous scattering elements.

Now referring to FIG. 12B, there is shown an illustration 1200B that depicts a subset of the plurality of scattering elements 106 of the scattering surface 108 of the DCS 104 for the first receiver 112A (i.e., Rxᵢ), and the second receiver 112B (i.e., Rx₂) consists of non-contiguous scattering elements.

Now referring to FIG. 12C, there is shown an illustration 1200C that depicts a subset of the plurality of scattering elements 106 of the scattering surface 108 of the DCS 104 for the first receiver 112A (i.e., Rxᵢ), and the second receiver 112B (i.e., Rx₂) consists of non-contiguous interleaved scattering elements.

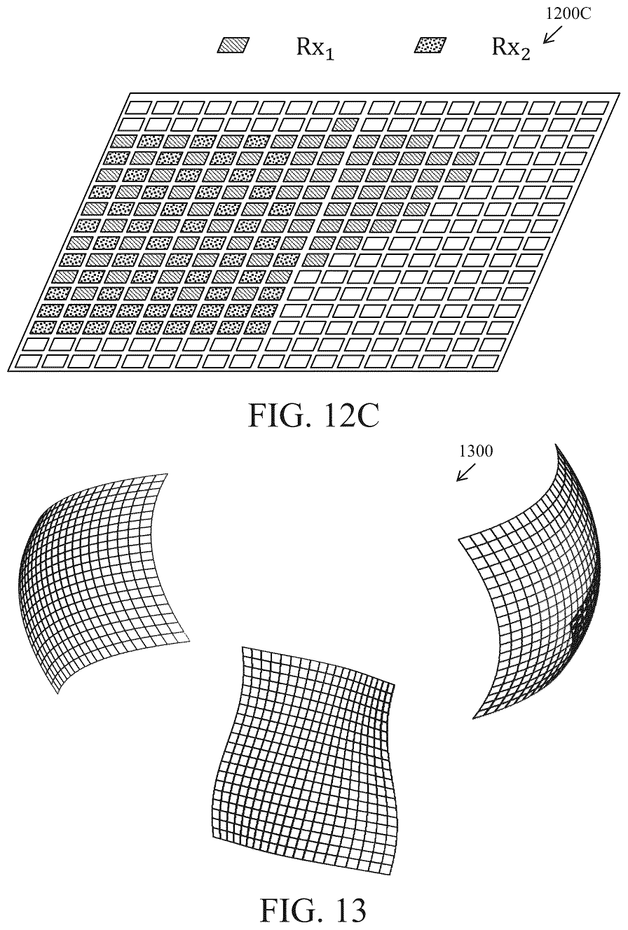

FIG. 13 illustrates exemplary configurations of a scattering surface of a DCS, in accordance with an embodiment of the present disclosure. FIG. 13 is described in conjunction with elements from FIGS. 1, 2, 3, 4, 5, 6, 7, 8, 9, 10, and 11. With reference to FIG. 13, there is shown an illustration 1300 that depicts exemplary configurations of the scattering surface 108 of the DCS 104. Alternatively stated, the DCS 104 may have different configurations or different shapes. For instance, the DCS 104 may have either a planar or a non-planar structure.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

What is claimed is:

1. A DCS controller (102) configured to control a digitally controllable scatterer, DCS, (104) to simultaneously serve a subset of the multiple receivers (112), the multiple receivers (112) comprising at least a first receiver (112A) and a second receiver (112B) being located in different locations, wherein the DCS (104) comprises a plurality of scattering elements (106) arranged on a scattering surface (108), and wherein the DCS controller (102) is configured to:
determine a single-user codeword for each of the multiple receivers (112), wherein the single-user codeword defines a set of scattering elements of the scattering surface of the DCS 104 for the respective receiver and a respective phase shift configuration for each scattering element in the set of scattering elements;
determine a required signal gain for each of the multiple receivers (112);
determine a subset of receivers based on the required signal gains;
determine a subset of scattering elements of the scattering surface for each receiver in the subset of receivers, wherein
the subset of scattering elements of the scattering surface for a receiver is determined to satisfy the required signal gain for that receiver and
subsets are disjoint;
determine a multiple-user codeword based on the subsets, wherein the multiple-user codeword defines the phase configuration for all subsets of scattering elements of the scattering surface (108) of the DCS (104); and
control the DCS (104) based on the multiple-user codeword for data transmission.

2. The DCS controller (102) according to claim 1, wherein the DCS controller (102) is further configured to determine the subset of receivers based on the single-user codewords.

3. The DCS controller (102) according to claim 1, wherein the DCS controller (102) is further configured to determine the subset of receivers based on the required signal gains so that the total required signal gains of the determined subset of receivers does not exceed a characteristic of the DCS (104).

4. The DCS controller (102) according to claim 1, wherein the DCS controller (102) is further configured to determine that the total required signal gains of the determined subset of receivers does not exceed the characteristic of the DCS (104) by determining that the total surface of the subsets of the scattering elements does not exceed the scattering surface of the DCS (104).

5. The DCS controller (102) of claim 4, wherein the DCS controller (102) is further configured to determine the subset of receivers based on a Lagrangian optimization solution maximizing a system metric subject to the resources available on the DCS (104).

6. The DCS controller (102) of claim 5, wherein the system metric is based on the number of users served by the DCS (104).

7. The DCS controller (102) of claim 6, wherein the system metric is the throughput being the sum rate of the rate of each user served.

8. The DCS controller (102) of claim 5, wherein the DCS controller (102) is further configured to determine the subset of receivers based on the Lagrangian optimization by determining an optimal constant based on the required Signal-to-Noise-Ratio, SNR, values for the two or more receivers, and solving the Lagrangian optimization by moving the optimal constant, μ*, until the total surface of the subsets of the scattering elements reaches the surface of the DCS (104).

9. The DCS controller (102) according to claim 1, wherein the DCS controller (102) is further configured to determine the multiple-user codeword based on the subsets of scattering elements by determining the reflective elements of the DCS (104) and corresponding phase shifts for each of the subsets and aggregating these reflective elements and corresponding phase shifts into the multiple-user codeword.

10. The DCS controller (102) according to claim 1, wherein the DCS controller (102) is further configured to determine a scattering pattern focusing on a receiver, the scattering pattern corresponding to the pattern of reflection from a perfect electric conductor with the shape of an ellipsoid (302) that has a first focal point being the location of a transmitter (304) and a second focal point being the location of the receiver (306), and wherein the single-user codeword is determined based on the scattering pattern.

11. The DCS controller (102) according to claim 10, wherein the DCS controller (102) is further configured to determine the set of scattering elements for a receiver (306) by:
determining a first plane (402) containing a main axis of the ellipsoid (302) and that intersects the ellipsoid (302);
determine a first intersect line (406) as the line where the first plane (402) intersects the DCS (104) surface;
determining a second plane (404) containing the main axis of the ellipsoid (302) and that intersects the ellipsoid (302);
determine a second intersect line (408) as the line where the second plane (404) intersects the DCS (104) surface; and
determining the set of scattering elements for the receiver (306) as a portion of the DCS (104) surface between the first intersect line (406) and the second intersect line (408).

12. The DCS controller (102) according to claim 11, wherein the DCS controller (102) is further configured to translate at least one of the first intersect line (406) and the second intersect line (408) to provide a higher required gain for the receiver (306).

13. The DCS controller (102) according to claim 10, wherein the DCS controller (102) is further configured to configure the scattering elements of the DCS (104) according to:
$${C}_{i} ( Tx , {Rx}_{i} , DCS ) = \{ {ϕ}_{M}^{i} = \frac{2 π {δ}_{m}}{λ} ≡ \frac{2 π}{λ} ( ‖ \vec{TxM} ‖ + ‖ \vec{{MRx}_{ι}} ‖ - ‖ \vec{TxV} ‖ - ‖ \vec{{VRx}_{ι}} ‖ ) [ 2 π ] , M ∈ DCS \}$$
wherein
Tx is the location of the transmitter (304)
Rxᵢ is the location of the receiver i (306)
M is the location of a scattering element on the DCS (104) surface
V is the point on the ellipsoid (302) where the line between M and Rxᵢ intersects the ellipsoid (302)
ϕ_{M}ⁱ is the phase shift applied by the DCS (104) at point M
δₘ is the path difference between the path through the DCS (104) at point M and the one through an ellipsoid PEC seen at the receiver (306) as coming from the same point M and
λ is the wavelength of the emitted signal.

14. The DCS controller (102) according to claim 1, wherein the DCS controller (102) is configured to select at least one of the single-user codewords from stored single-user codewords.

15. The DCS controller (102) according to claim 1, wherein the DCS controller (102) is configured to construct at least one of the single-user codewords.

16. The DCS controller (102) according to claim 1, wherein the DCS controller (102) is further configured to determine the subset of receivers by receiving scheduling information, indicating which receivers are scheduled to be active, and only determine required signal gains for the receivers that are scheduled to be active.

17. The DCS controller (102) according to claim 1, wherein the DCS controller (102) is further configured to determine the subset of receivers by receiving scheduling information, indicating which receivers are scheduled to be prioritized, and determine the subset of receivers to include the receivers that are to be prioritized.

18. The DCS controller (102) according to claim 1, wherein the DCS (104) comprises scattering elements and wherein the DCS controller (102) is further configured to determine the multiple-user codeword based on the subsets of scattering elements by assigning to the scattering elements of each subset of scattering elements the phase shift specified by its corresponding single user codeword and aggregating these scattering elements and corresponding phase shifts for all subsets of scattering elements into the multiple-user codeword.

19. The DCS controller (102) according to claim 1, wherein a subset of the scattering elements of the DCS (104) surface for a receiver (306) consists of contiguous scattering elements.

20. A method (1100) for use in a DCS controller (102) configured to control a DCS (104) to simultaneously serve a subset of the multiple receivers (112), the multiple receivers (112) comprising at least a first receiver (112A) and a second receiver (112B) being located in different locations, wherein the DCS (104) comprises a plurality of scattering elements (106) arranged on a scattering surface (108), and wherein the method (1100) comprises:
determining a single-user codeword for each of the multiple receivers (112), wherein a single-user codeword defines the phase configuration for a set of scattering elements of the scattering surface (108) of the DCS (104) for the respective receiver and a respective phase shift configuration for each scattering element in the set of scattering elements;
determining a required signal gain for each of the multiple receivers (112);
determining a subset of receivers based on the required signal gains, wherein the total required signal gains of the determined subset of receivers does not exceed a characteristic of the DCS (104);
determining a subset of scattering elements for each receiver in the subset of receivers, wherein
the subset for a receiver is determined to satisfy the required signal gain for that receiver and
subsets are disjoint;
determining a multiple-user codeword based on the subsets of scattering elements, wherein the multiple-user codeword defines all subsets of scattering elements of the scattering surface (108) of the DCS (104); and
controlling the DCS (104) based on the multiple-user codeword for data transmission.
